(19) United States
(12) Patent Application Publication
(10) Pub. No.: US 2019/0011653 A1
(43) Pub. Date: Jan. 10, 2019

(54) OPTICAL MODULE

(71) Applicant: SUMITOMO ELECTRIC INDUSTRIES, LTD., Osaka (JP)

(72) Inventors: Takashi YAMADA, Osaka (JP); Takayuki SHIMAZU, Osaka (JP)

(73) Assignee: SUMITOMO ELECTRIC INDUSTRIES, LTD., Osaka (JP)

(21) Appl. No.: 16/018,638

(22) Filed: Jun. 26, 2018

(30) Foreign Application Priority Data
Jul. 4, 2017 (JP) 2017-131456

(51) Int. Cl. G02B 6/42

(52) U.S. Cl. CPC G02B 6/4249; G02B 6/423; G02B 6/4212; G02B 6/4274; G02B 6/4244; G02B 6/424

(57) ABSTRACT

An optical module that includes an optical holding member and an optical device is disclosed. The optical holding member includes a first surface, a second surface, a first hole extending from the first surface toward the second surface, a second hole extending from the second surface toward the first surface, and a lens provided between the first and second holes. The lens includes a first lens surface adjacent to the first hole. The optical device includes an optical region on a surface of the optical device. The optical device is mounted on the first surface of the optical coupling member such that the optical region faces the first hole. In the optical module, the central axis of the first hole, the optical axis of the first lens surface, and the central axis of the second hole are located on the identical axis.

### CROSS-REFERENCE TO RELATED APPLICATION

The present application claims the benefit of priority of Japanese Patent Application No. 2017-131456, filed on Jul. 4, 2017, the content of which is incorporated herein by reference in its entirety.

### TECHNICAL FIELD

The present invention relates to an optical module.

### BACKGROUND

Japanese Unexamined Patent Publication No. JP2007-094153 discloses an optical module having a structure where an optical semiconductor device and an optical fiber face each other. In the optical module, the optical semiconductor device is mounted on a holding member such that a light receiving/emitting surface of the optical semiconductor device faces an opening of a holding hole of a holding member. The optical semiconductor device is optically coupled to the optical fiber inserted into the holding hole.

### SUMMARY

This disclosure provides an optical module comprising an optical coupling member and an optical device. The optical coupling member includes a first surface, a second surface opposite to the first surface, a first hole extending from the first surface toward the second surface, a second hole extending from the second surface toward the first surface, and a lens provided between the first and second holes. The lens includes a first lens surface adjacent to the first hole. The optical device comprises an optical region that includes at least one of a light emitting region or a light receiving region on a surface of the optical device. The optical device is mounted on the first surface of the optical coupling member such that the optical region faces the first hole. The central axis of the first hole, the optical axis of the first lens surface, and the central axis of the second hole are located on the identical axis.

### BRIEF DESCRIPTION OF THE DRAWINGS

The foregoing and other purposes, aspects and advantages will be better understood from the following detailed description of embodiments of the invention with reference to the drawings, in which:

FIG. 1 is a perspective view of an optical module according to one embodiment;

FIG. 2 is a perspective view of an optical coupling member of the optical module shown in FIG. 1;

FIG. 3 is a perspective view of an optical device of the optical module shown in FIG. 1;

FIG. 4 is a sectional view showing a connection structure between the optical coupling member and the optical device that are included in the optical module shown in FIG. 1;

FIG. 5 is a sectional view showing a modification example of a connection structure between the optical coupling member and the optical device that are included in the optical module shown in FIG. 1;

FIG. 6 is a sectional view of an optical module according to another embodiment;

FIG. 7 is a sectional view of an optical module according to another embodiment;

FIG. 8 is a diagram showing an optical coupling efficiency in a comparative example;

FIG. 9 is a diagram showing an optical coupling efficiency in a first example;

FIG. 10 is a diagram showing the optical coupling efficiency in the first example; and

FIG. 11 is a diagram showing an optical coupling efficiency in a second example.

### DETAILED DESCRIPTION

### Problem to be Solved by this Disclosure

The optical module described in JP2007-094153 applies a so-called direct optical coupling, which is a butt joint coupling, to a coupling between a light receiving/emitting device and an optical fiber. It is, however, difficult for the direct optical coupling to enclose the entire light from the light emitting device in the optical fiber if the numerical aperture (NA) of the light emitting device is larger than the NA of the optical fiber. Accordingly, a light coupling loss occurs. Meanwhile, it is also difficult for the direct optical coupling to receive the entire light from the optical fiber with the light receiving device if the light receiving diameter of the light receiving device is smaller than the diameter of light emitted from the optical fiber. Accordingly, a light coupling loss occurs. In such an optical module, according to the characteristics of the device, the light emitting device with a high response speed (e.g., VCSEL etc.) tends to have a large NA, while the light receiving device with a high response speed tends to have a small light receiving diameter. Consequently, the higher the required response speed is, the more difficult the achievement of a high optical coupling efficiency in the optical module configuration described above is.

### Advantageous Effect of this Disclosure

The optical module according to this disclosure can achieve a high optical coupling efficiency.

### Description of Embodiment of Present Invention

In accordance with an embodiment of the present invention, an optical module of an aspect of the present invention comprises an optical coupling member and an optical device. The optical coupling member comprises a first surface, a second surface opposite to the first surface, a first hole extending from the first surface toward the second surface, a second hole extending from the second surface toward the first surface, and a lens provided between the first and second holes. The lens includes a first lens surface adjacent to the first hole. The optical device comprises an optical region that includes at least one of a light emitting region or a light receiving region on a surface of the optical device. The optical device is mounted on the first surface of the optical coupling member such that the optical region faces the first hole. The central axis of the first hole, the optical axis of the first lens surface, and the central axis of the second hole are located on the identical axis.

The above optical module provides a lens between the first and second holes of the optical coupling member, and the lens has a first lens surface adjacent to the first hole. In this optical module, the central axis of the first hole, the optical axis of the first lens surface, and the central axis of the second hole are located on the identical axis. Accordingly, the first lens surface can condense the light from the optical fiber or the light from the optical device in a preferable manner, in the case where the optical fiber is inserted into the second hole. That is, even if the NA of the optical device (light emitting device) is larger than the NA of the optical fiber, adjustment such as light condensing can be applied to the light from the optical device (light emitting device) by means of the first lens surface to cause the light to enter the optical fiber without causing a coupling loss. Furthermore, even if the light receiving diameter of the optical device (light receiving device) is smaller than the diameter of the emitted light, adjustment such as light condensing can be applied to the light from the optical fiber by means of the first lens surface to cause the light to enter the optical device without causing a coupling loss. Thus, the above optical module can reduce the light coupling loss so as to achieve a high optical coupling efficiency. It is preferable that the configuration of the optical module be applied to the case where the NA of the optical device (light emitting device) is larger than the NA of the optical fiber or the case where the light receiving diameter of the optical device (light receiving device) is smaller than the diameter of the light emitted from the optical fiber. However, the application is not limited to these cases. It is a matter of course that the application may be made to a case where the NA of the optical device (light emitting device) is smaller than the NA of the optical fiber or the case where the light receiving diameter of the optical device (light receiving device) is larger than the diameter of the light emitted from the optical fiber. Also in these cases, a high optical coupling efficiency can be achieved. This is analogously applicable to the following embodiments.

In addition to the above, the configuration where the lens is provided between the first and second holes prevents an adhesive from coming into contact with the optical surface of the optical device provided near the first hole when the adhesive is used to fix the optical fiber into the second hole. Thus, this configuration can prevent the metal, such as electrodes provided on the optical surface of the optical device from reacting with the adhesive, or prevent the stress due to the resin included in the adhesive from being applied to the optical device. Consequently, the optical module with the above configuration can improve its reliability.

In an embodiment of the optical module, the depth of the first hole from the first surface to the first lens surface may be smaller than the diameter of the first hole. This embodiment can suppress the thermal deformation of the optical coupling member around the first hole when the optical device is joined to the optical coupling member by heating means. Therefore, this embodiment can improve the reliability of the optical module. In a similar way, the depth of the first hole from the first surface to the first lens surface may be shorter than the depth of the second hole from the second surface to the lens. The depth of the first hole from the first surface to the first lens surface may be shorter than a longitudinal length of the lens.

In an embodiment of the optical module, the second hole may have a constant diameter from the second surface to the lens. This embodiment can accurately hold the optical fiber inserted into the second hole without axial deviation. Therefore, this embodiment can improve the optical coupling efficiency of the optical module.

In an embodiment of the optical module, the first hole may have a constant diameter from the first surface to the lens, and the diameter of the first hole is equivalent to the diameter of the second hole. This embodiment improves the symmetric property of the optical coupling member. Accordingly, in a case where the optical device is connected to the optical coupling member by heating means, the thermal deformation over the entire optical coupling member is easily made uniform. Non-uniform thermal deformation becomes difficult to occur in this embodiment. Therefore, this embodiment can improve the reliability of the optical module.

In an embodiment of the optical module, the optical coupling member may further include a first electrode on the first surface and the optical device may further include a second electrode on the surface of the optical device. The first electrode and the second electrode may be electrically connected to each other. This embodiment can electrically connect the optical device to an external substrate or the like via the optical coupling member, with a simple configuration.

In the above embodiment, the first electrode of the optical coupling member and the second electrode of the optical device may be joined to each other via AuSn solder. Since the optical device is joined to the optical coupling member by melting the AuSn solder in this embodiment, this embodiment can improve the accuracy of the distance between the optical device and the first lens surface, in comparison with the case where Au or Cu bumps are formed and the optical device is joined to the optical coupling member by heat or ultrasonic waves. Thus, this embodiment can improve the optical coupling efficiency. Furthermore, the connection using AuSn solder can improve the joining strength between the first electrode and the second electrode, that is, the joining strength between the optical coupling member and the optical device.

In an embodiment of the optical module, the lens may have permeability which allows light having a predetermined wavelength to transmit therethrough. This embodiment suppresses absorption of the light through the lens. Consequently, the optical coupling efficiency can be further improved. Herein described “permeability which allows light . . . to transmit” means that the total light transmittance of predetermined light (e.g., light with a wavelength of 850 nm) at a thickness of 1 mm is 90% or higher. For example, the transmittance can be measured in conformity with JIS K 7361-1.

In an embodiment of the optical module, the optical coupling member may include a main body having the first and second holes internally configured in the main body. The main body may be formed of a material transparent to visible light. Since the visibility is improved in this embodiment, the positional relationships of the members can be easily identified in a case where the optical device is mounted on the optical coupling member, and the members can be mounted more smoothly. Herein described “transparent to visible light” means that the total light transmittance of visible light (e.g., light with a wavelength ranging from 480 to 670 nm) at a thickness of 1 mm is 60% or higher. For example, the transmittance can be measured in conformity with JIS K 7361-1.

In an embodiment of the optical module, the lens may be formed integrally with the main body. This embodiment can easily achieve arrangement of the central axis of the first hole, the optical axis of the first lens surface, and the central axis of the second hole on the identical axis, and can reduce the optical axis deviation and the variation in distance between the components. Thus, this embodiment can improve the optical coupling efficiency with the simple configuration. In addition, as the lens and the main body are integrally formed, this embodiment can reduce the production cost of the optical module.

In an embodiment of the optical module, the lens may be formed of the same material as that of the main body. According to this embodiment, even in a case where the environmental temperature is changed, the stress deformation due to the difference in linear expansion coefficient between the main body of the optical coupling member and the lens is unlikely to occur. Consequently, the deviation in the optical axis of the lens and the variation in the distances between the members become small. Therefore, this embodiment can allow a wide operation temperature range of the optical module, and can achieve a high optical coupling efficiency even in case the temperature varies.

In an embodiment of the optical module, the main body may be formed of a heat-resistant material. This embodiment can improve the heat resistance (reflowing resistance) of the optical coupling member. If the main body of the optical coupling member is formed of a heat-resistant material, the thermal variation on the optical coupling member is small, even in the case where AuSn solder having a high mounting accuracy is melted at a high temperature (around a melting point 280° C.) to join the optical device to the optical coupling member. Consequently, the position accuracy of the mounting can be improved. Examples of the herein adopted “heat-resistant material” include silica glass, and various heat-resistant resins (e.g., U Polymer® that is a polyarylate resin, ARTON® that is a cyclic olefin resin, a thermoplastic resin such as TERALINK®, and a thermosetting resin, such as epoxy or silicone). However, the material is not limited to these examples. The silica glass and the heat-resistant resin described above can sometimes be used as a transparent material.

In an embodiment of the optical module, the optical coupling member further includes a stopper or a stop surface that is provided in the second hole and regulates the distal end position of the optical fiber, which has been inserted into the second hole, at the position apart from the lens. This embodiment improves the position accuracy of the optical fiber, thereby allowing the optical coupling efficiency to be further improved. Moreover, the contact of the optical fiber with the optical device during insertion of the optical fiber into the second hole is more reliably suppressed. Consequently, the operation of inserting the optical fiber can be performed easily, and the productivity of the entire device can be improved.

In an embodiment of the optical module, the lens may further include the second lens surface adjacent to the second hole. The optical axis of the second lens surface may coincide with the central axis of the second hole. This embodiment comprises not only the first lens surface provided toward the first hole but also the second lens surface provided toward the second hole. Accordingly, this embodiment can further improve the optical coupling efficiency. The first lens surface may be located in a bottom of the first hole and the second lens surface may be located in a bottom of the second hole.

In an embodiment of the optical module, the optical module may further comprise the optical fiber inserted into the second hole. This embodiment can configure the optical module that comprises the optical fiber, and the optical coupling between the optical device and the respective optical fiber can be preliminarily adjusted. In this embodiment, the distal end of the optical fiber may be apart from the surface of the optical device. In addition, the optical module may further comprise a drive circuit configured to control the optical device, a circuit board that mounts the optical coupling member and the drive circuit thereon, and at least one electrode disposed on the circuit board. The electrode may electrically connect the drive circuit to the optical device through the optical coupling member.

### Details of Embodiments of the Present Invention

Hereinafter, an optical module according to an embodiment is described in detail with reference to the drawings. The present invention is not limited to these examples and is indicated by the scope of claims, and meanings equivalent to the scope of claims and all the modifications within the scope are intended to be included. In each drawing, the same or corresponding parts are assigned the same symbols, and redundant description is omitted.

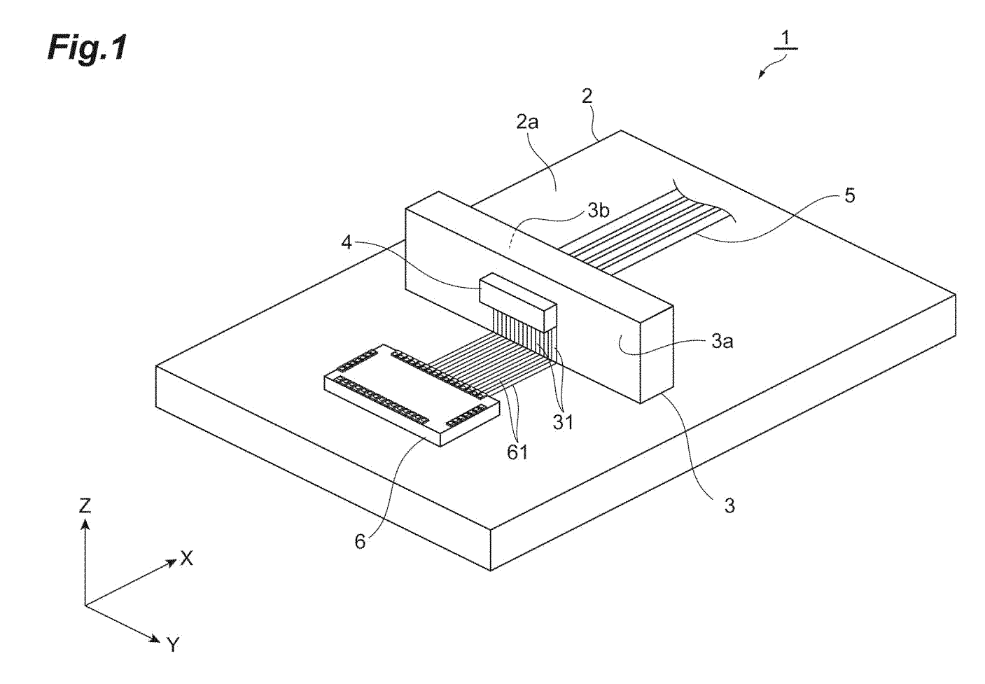

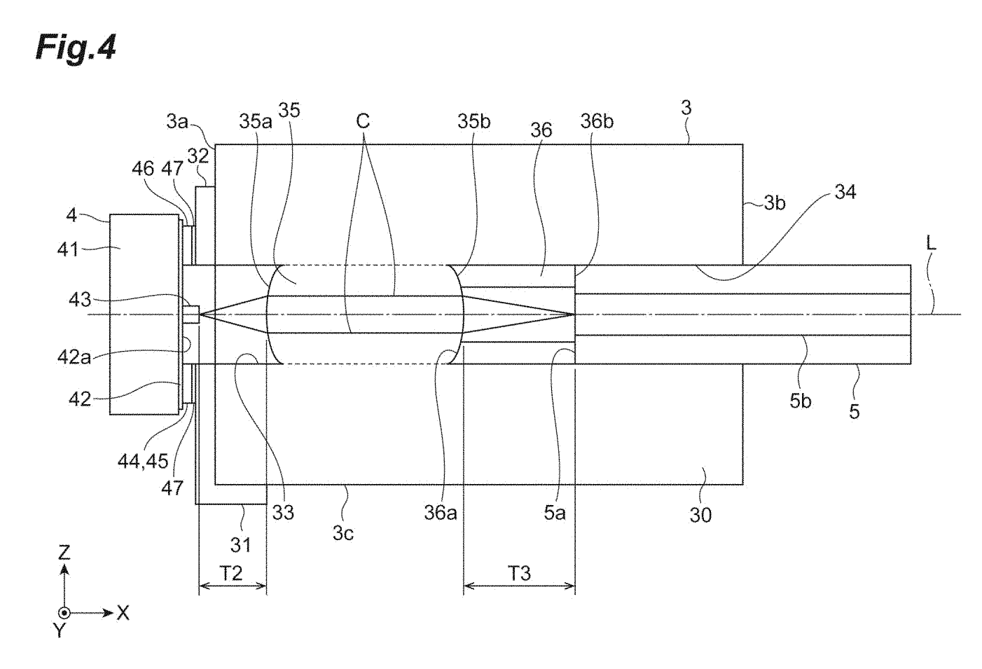

FIG. 1 is a perspective view of an optical module according to one embodiment. As shown in FIG. 1, the optical module 1 comprises a circuit board 2, an optical coupling member 3, an optical device 4, a plurality of optical fibers 5, and a drive circuit 6. The circuit board 2 includes a principal surface 2a extending in an X-Y plane. The optical coupling member 3 and the drive circuit 6 are mounted on the principal surface 2a. The optical device 4 includes a light emitting device, such as a surface emitting laser (VCSEL: Vertical Cavity Surface Emitting Laser), or a light receiving device, such as a photodiode (PD), or a combination of both the devices. The optical device 4 is mounted at a substantially center of one surface 3a of the optical coupling member 3. The optical device 4 is electrically connected to the drive circuit 6 via a plurality of electrodes 31 provided on the surface 3a of the optical coupling member 3 and a plurality of electrodes 61 provided on the principal surface 2a of the circuit board 2. Although described later in detail, optical fibers 5 optically coupled to the optical device 4 by the optical coupling member 3 are inserted into respective holes 34 (see FIG. 4) provided on a surface 3b of the optical coupling member 3 opposite to the surface 3a, and held at their one ends.

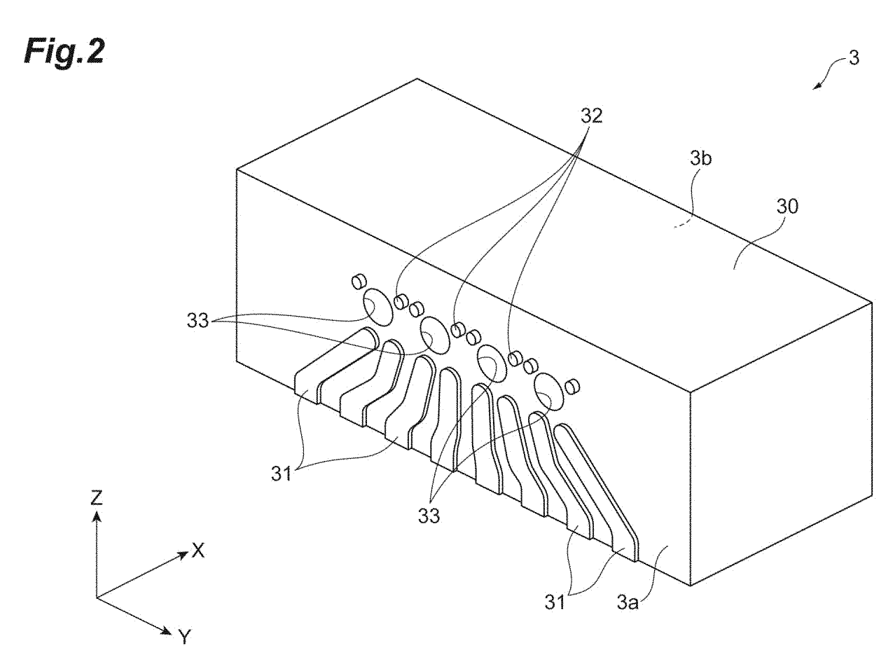

FIG. 2 is a perspective view of the optical coupling member 3 of the optical module shown in FIG. 1. As shown in FIG. 2, the optical coupling member 3 includes a main body 30 having a rectangular shape. The main body 30 is formed of a material that is transparent to visible light, and may be formed of, for example, silica glass, a thermoplastic resin (polyarylate resin (e.g., U Polymer®), a cyclic olefin resin (e.g., ARTON®) or TERALINK®, etc.), or a thermosetting resin (epoxy, silicone, etc.). At the main body 30 of the optical coupling member 3 formed of the transparent material, for example, the total light transmittance for visible light having the wavelength ranging from 480 to 670 nm can be 60% or higher in a case where the thickness is 1 mm. Accordingly, when the optical device 4 is mounted on the optical coupling member 3, the mounting can be made while the mutual positional relationship is confirmed. The main body 30 of the optical coupling member 3 may be formed of a heat-resistant material. For example, the main body 30 can be formed of the transparent and heat-resistant resin. As the optical coupling member 3 or the main body 30 has heat resistance, adverse effects due to heat (expansion, deformation, etc.) in a case where the optical device 4 is mounted on the optical coupling member 3 or a case where the optical coupling member 3 is mounted on the circuit board 2 by a reflowing process can be reduced.

The first surface 3a of the optical coupling member 3 is provided with the plurality of (eight in this embodiment) electrodes 31, and a plurality of (eight in this embodiment) mechanical pads 32. The first surface 3a of the optical coupling member 3 is provided with a plurality of (four in this embodiment) holes 33 that extend, toward the second surface 3b disposed on the opposite side, to the middle. The numbers of first electrodes 31, mechanical pads 32 and first holes 33 correspond to the number of light receiving regions or light emitting regions (hereinafter also represented as “light receiving/emitting regions”) (four light emitting regions or light receiving regions in this embodiment), which are included in the optical device 4. Each light receiving/emitting region is provided with a pair of first electrodes 31, one or two (two in this embodiment) mechanical pads 32, and one first hole 33. The main body 30 of the optical coupling member 3 may be a minute member having a distance (thickness) of about 1 mm between the first and second surfaces 3a and 3b, for example.

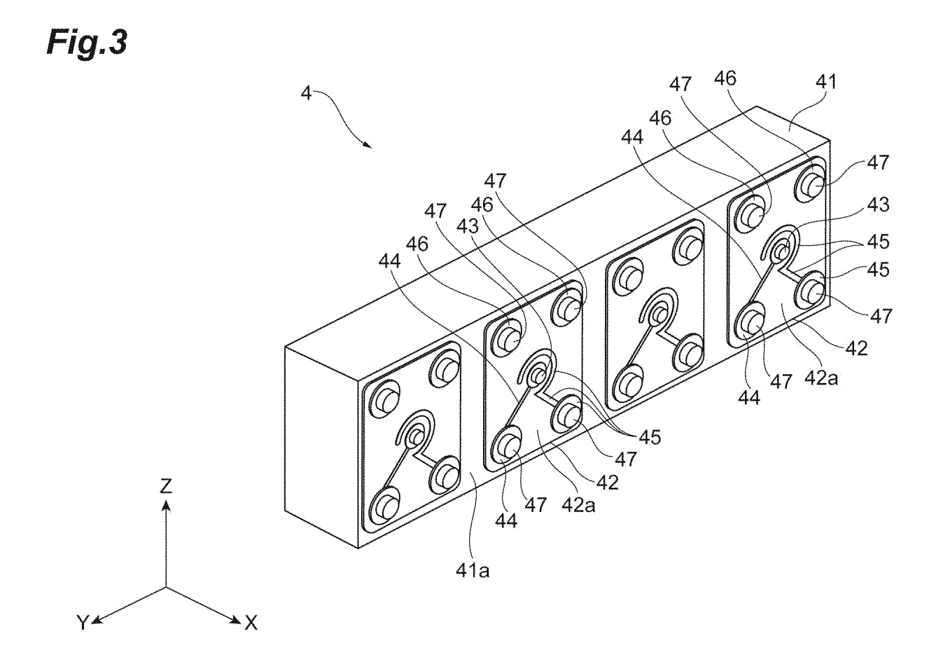

FIG. 3 is a perspective view of the optical device 4 of the optical module shown in FIG. 1. As shown in FIG. 3, the optical device 4 is, for example, a VCSEL chip, and comprises a substrate 41, and a plurality of (four in this embodiment) channels 42. The plurality of channels 42 are disposed on a surface 41a of the substrate 41 in a manner arranged next to each other along a Y-axis direction. The center interval between the channels 42 in the Y-axis direction corresponds to the center interval between the holes 33 of the optical coupling member 3 in the Y-axis direction. Each channel 42 includes a surface 42a, and further includes a light emitting region 43 on the surface 42a, an anode electrode 44 on the same side as that of the light emitting region 43, a cathode electrode 45 on the same side as that of the light emitting region 43, and a mechanical pad 46 electrically insulated from the other members. In the above description, the case where the plurality of light emitting regions 43 are formed on the common substrate 41 and integrated to be the optical device 4 is described. Alternatively, each light emitting region 43 or each light receiving region 43 may be formed on an individual substrate. In the above description, the case where the optical device 4 is the light emitting element is described. Alternatively, the optical device 4 may be a light receiving element, such as a PD, or what includes a light emitting element and a light receiving element in a mixed manner. Further alternatively, this device may comprise a device that includes only one light emitting region or one light receiving region. In the case where the optical device 4 includes the light emitting device and the light receiving device in the mixed manner, the light emitting device and the light receiving device may be formed on another common substrate. In the case where the optical device 4 comprises the device that includes one light emitting region or one light receiving region, one first hole 33 or the like is provided for the optical coupling member 3.

Next, referring to FIG. 4, the connection structure between the optical coupling member 3 and the optical device 4 in the optical module 1 is described further in detail. FIG. 4 is a sectional view showing the connection structure between the optical coupling member 3 and the optical device 4 that are included in the optical module 1 shown in FIG. 1.

As shown in FIG. 4, the optical coupling member 3 comprises the first holes 33, the second holes 34, lenses 35 disposed between the first and second holes 33 and 34, and optical fibers 5 inserted into the second holes 34, substantially at the center of the inside of the main body 30. The optical device 4 is mounted on the surface 3a of the optical coupling member 3 such that the surfaces 42a (light receiving/emitting regions 43) face the first holes 33. The electrodes 31 of the optical coupling member 3 and the electrodes 44 and 45 of the optical device 4 are joined via AuSn solder layers 47. The mechanical pads 32 of the optical coupling member 3 and the mechanical pads 46 of the optical device 4 are joined via AuSn solder layers 47. Alternatively, the joining may be made with Au or Cu bumps. Referring to FIG. 4, the first and second holes 33 and 34, the lens 35, and the optical fiber 5 that correspond to the single light receiving/emitting region 43 (channel 42) in the optical device 4 are described. Likewise, the structures of the holes and the like corresponding to the other light emitting/receiving regions 43 are analogous. The description thereof is omitted. In this embodiment, the AuSn solder layers 47 are preliminarily formed for the electrodes 44 and 45 and the mechanical pads 46 of the optical device 4 (see FIG. 3), and is joined to the electrode 31 and the mechanical pad 32 of an optical coupling member 3. Alternatively, the AuSn solder layers 47 may be preliminarily formed for the electrode 31 and the mechanical pad 32 of the optical coupling member 3, and may be joined to the electrodes 44 and 45 and the mechanical pad 46 of the optical device 4.

The first hole 33 of the optical coupling member 3 extends from the first surface 3a toward the second surface 3b up to the lens 35 disposed at the middle thereof. On the first surface 3a of the main body 30, for example, openings of the four first holes 33 are sequentially formed along the Y-axis direction (see FIG. 2). The diameter of the first hole 33 is constant from the first surface 3a to a first lens surface 35a of the lens 35 described later, and may be about 128 μm, for example. A depth of the first hole 33 (the minimum distance from the first surface 3a to the first lens surface 35a) may be 80 μm, for example, and is configured to be shorter than the diameter of the first hole 33 and shorter than the length of the lens 35 in an X-direction.

The plurality of (four in this embodiment) second holes 34 are formed on the second surface 3b of the optical coupling member 3. The second hole 34 extends from the second surface 3b toward the first surface 3a up to the lens 35 disposed at the middle thereof. On the second surface 3b of the main body 30, for example, openings of the four second holes 34 are sequentially formed along the Y-axis direction. The diameter of the second hole 34 is constant from the second surface 3b to a second lens surface 35b of the lens 35 described later, and may be about 128 μm, for example. The diameter of the second hole 34 may be equivalent to or different from the diameter of the first hole 33. The depth of the second hole 34 (the minimum distance from the second surface 3b to the second lens surface 35b) is configured to be longer than the depth of the first hole 33, for example. That is, the depth of the first hole 33 is shorter than the depth of the second hole 34.

The lens 35 is provided between the first hole 33 and the second hole 34. The lens 35 may be formed integrally with the main body 30 of the optical coupling member 3, or may be formed by inserting or pressing a lens member into the middle of the hole that penetrates through the hole corresponding to the first and second holes 33 and 34 of the main body 30 and by fixing the member at a predetermined position. The lens 35 is formed of a material that allows communication light having a predetermined wavelength to transmit therethrough. It is preferable that the total light transmittance be 90% or higher for light having a wavelength of about 850 nm in the case of a thickness of 1 mm, for example. The lens 35 may be formed of the same material as that of the main body 30.

The lens 35 is provided with the first lens surface 35a adjacent to the first hole 33, and is provided with the second lens surface 35b adjacent to the second hole 34. The first lens surface 35a is located in a bottom of the first hole 33 and is convex toward the first surface 3a so as to collimate the light from the optical device 4. The second lens surface 35b is located in a bottom of the second hole 34 and is convex toward the second surface 3b so as to condense the parallel light having entered the first lens surface 35a and cause the light to enter a core 5b of the optical fiber 5. The length of the lens 35 along the X-direction may be, for example, about 200 μm. The outer diameter may be, for example, about 128 μm. To allow the light from the optical device 4 to enter the core 5b of the optical fiber 5 with a high optical coupling efficiency, the optical coupling member 3 is configured such that the central axis of the first hole 33, the optical axes of the first and second lens surfaces 35a and 35b of the lens 35, and the central axis of the second hole 34 (the optical axis of the optical fibers 5) are positioned on an identical axis L.

The optical coupling member 3 further provides a stopper 36 near the lens 35 in the second hole 34. The stopper 36 regulates the position of a distal end 5a of the optical fiber 5 inserted into the hole 34, at a position apart from the lens 35. The stopper 36 has a cylindrical shape extending along the X-axis. The outer diameter of the stopper 36 may be 128 μm and the length thereof may be about 135 μm, for example. The stopper 36 includes a first stop surface 36a, and a second stop surface 36b. The first stop surface 36a is in contact with an outer periphery of the second lens surface 35b of the lens 35, and is thus configured so that the stopper 36 cannot be further inserted. The second stop surface 36b is disposed toward the second surface 3b, and is in contact with the distal end 5a of the optical fiber 5, thereby preventing the optical fiber 5 from being further inserted. The stopper 36 may be formed integrally with the main body 30 of the optical coupling member 3.

On the lower side of the first holes 33 on the first surface 3a of the optical coupling member 3, the first electrodes 31 are provided. The first electrodes 31 each extend to the lower surface 3c along the Z-axis direction. As shown in FIG. 2, the plurality of first electrodes 31 are arranged along the Y-axis direction. A pair of first electrodes 31 corresponds to one first hole 33. On the upper side of the first holes 33 on the first surface 3a of the optical coupling member 3, the substantially disc shaped mechanical pads 32 are provided. As shown in FIG. 2, the plurality of mechanical pads 32 are arranged along the Y-axis direction. One or two mechanical pads 32 correspond to the pair of first electrodes 31 and one first hole 33.

As shown in FIG. 4, the optical device 4 is disposed to face the optical coupling member 3. Specifically, the optical device 4 is mounted on the first surface 3a of the optical coupling member 3 such that the channels 42 face the respective first holes 33. Such mounting causes the surfaces 42a of the channels 42 to face the respective first holes 33. The channels 42 of the optical device 4 include the light emitting regions 43, and are adjusted so that the optical axes of light beams emitted from the light emitting regions 43 are disposed on the respective axes L. The electrodes 44 and 45 of the optical device 4 are joined to the first electrodes 31 of the optical coupling member 3 via the AuSn solder layers 47, and are further connected to the drive circuit 6 via the electrodes 61 shown in FIG. 1. The mechanical pads 46 of the optical device 4 are joined to the respective mechanical pads 32 of the optical coupling member 3 via the AuSn solder layers 47, and are mounted so that the optical device 4 is in parallel to the first surface 3a of the optical coupling member 3.

The optical fibers 5 are inserted into the respective second holes 34. The optical fiber 5 is inserted into the second hole 34 so that the distal end 5a is in contact with the second stop surface 36b of the stopper 36. That is, the distal end position of the optical fiber 5 is regulated by the second stop surface 36b of the stopper 36. Accordingly, the position of the optical fiber 5 with respect to the optical coupling member 3 is defined. The outer diameter of the optical fiber 5 may be configured to be about 125 μm, for example, and is an outer diameter substantially equivalent to (slightly smaller than) the diameter of the second hole 34. Accordingly, the optical axis of the optical fiber 5 easily coincides with the optical axes of the first and second lens surfaces 35a and 35b. The optical fiber 5 may be configured to be inserted into the second hole 34 using a ferrule.

FIG. 1 is herein referred to again. In the optical module 1 having the configuration described above, the drive circuit 6 that comprises an integrated circuit (IC) is electrically connected to the optical device 4 via the electrodes 61, the electrodes 31 and the electrodes 44 and 45. Reception and emission light of the optical device 4 is controlled by electric signals from the drive circuit 6. In the case where the optical device is the light emitting device, the optical module 1 allows light from the optical devices 4 to enter the optical fibers 5 via the lenses 35 of the optical coupling member 3. More specifically, as shown in FIG. 4, when drive signals are input into the optical device 4 via the electrodes and the like by the drive circuit, light emission is executed by the channels 42 of the optical device 4, and then the light C enters the first lens surfaces 35a of the lenses 35. The light C having entered the lenses 35 is converted into collimated light by the first lens surfaces 35a, propagates through the lenses 35 along the X-axis direction, and is condensed by the second lens surfaces 35b. The condensed light C enters the cores 5b of the optical fibers 5. On the other hand, in a case where the optical device 4 is the light receiving device, the light C having propagated through the optical fibers 5 enters the second lens surfaces 35b of the lenses 35. The light C having entered the lenses 35 is converted into collimated light by the second lens surfaces 35b, propagates through the lenses 35 along the X-axis direction, and is condensed by the first lens surfaces 35a. The condensed light C enters the optical device 4, which is the light receiving device. The light having entered the optical device 4 is photoelectrically converted by the optical device 4, and electrical signals are output to the drive circuit 6. In the optical module 1, the optical device 4 and the drive circuit 6 are connected to each other via the electrodes 61 and the like on the circuit board 2. The configuration is not that provided with bonding wires between the optical device 4 and the drive circuit 6. Consequently, the device can have a low profile.

The action and effects obtained by the optical module 1 are described. In the optical module 1, the optical coupling member 3 is provided with the lenses 35 between the first holes 33 and the second holes 34. The lens 35 includes the first lens surface 35a adjacent to the first hole 33. The central axis of the first hole 33, the optical axis of the first lens surface 35a, and the central axis of the second hole 34 are positioned on the identical axis L. Accordingly, the first lens surface 35a or the second lens surface 35b can collimate or condense the light from the optical device 4 or the light from the optical fiber 5 in the case where the optical fiber 5 is inserted into the second hole 34. Even if the NA of the optical device 4 is larger than the NA of the optical fiber 5, the first and second lens surfaces 35a and 35b adjust the NA of the light from the optical device 4 and cause the light to enter the optical fiber 5. Consequently, the light coupling loss can be reduced. Even if the light receiving diameter of the optical device 4 (light receiving element) is smaller than the diameter of the light emitted from the optical fiber 5, the first and second lens surfaces 35a and 35b condense the light from the optical fiber 5, and cause the light to enter the optical device 4. Consequently, the light coupling loss can be reduced. Therefore, the optical module 1 can achieve a high optical coupling efficiency.

In the optical module 1, the lens 35 is provided between the first and second holes 33 and 34. Consequently, the lens 35 prevents the adhesive from infiltrating to the optical device 4 even if an adhesive for fixing the optical fiber 5 is introduced in the second hole 34. Therefore, the optical module 1 prevents the optical device 4 from reacting with the adhesive, thereby allowing the reliability of the device to be improved.

In the optical module 1, the depth of the first hole 33 from the first surface 3a to the first lens surface 35a is smaller than the diameter of the first hole 33. Consequently, thermal deformation of the optical coupling member 3 around the first holes 33 can be suppressed even if the optical device 4 is connected to the optical coupling member 3 by heating means. Therefore, the reliability of the optical module 1 can be improved.

In the optical module 1, the depth of the first hole 33 from the first surface 3a to the first lens surface 35a is smaller than the length of the lens 35. Consequently, thermal deformation of the optical coupling member 3 around the first holes 33 can be suppressed even if the optical device 4 is connected to the optical coupling member 3 by heating means. Therefore, the reliability of the optical module 1 can be improved.

In the optical module 1, the diameter of the second hole 34 is constant from the second surface 3b to the lens 35. Accordingly, the optical fibers 5 inserted into the second holes 34 can be reliably supported by the optical coupling member 3. Therefore, the optical module 1 can suppress the deviation of the optical axes between the optical fibers 5 and the optical device 4.

In the optical module 1, the diameter of the first hole 33 is constant from the first surface 3a to the lens 35, and is equivalent to the diameter of the second hole 34. Since the symmetric property of the optical coupling member 3 is improved in this configuration, variation due to heat becomes uniform even if the optical device 4 is connected to the optical coupling member 3 by heating means, thereby suppressing thermal deformation of the optical coupling member 3 around the first holes 33. Therefore, the reliability of the optical module 1 can be improved.

In the optical module 1, the optical coupling member 3 includes the first electrodes 31 on the first surface 3a, and the optical device 4 includes the second electrodes 44 and 45 on the surface 42a opposite to the first surface 3a. The first electrodes 31 and the second electrodes 44 and 45 are electrically connected to each other. Accordingly, the optical module 1 allows the optical device 4 to be electrically connected to the external drive circuit 6 by a simple configuration. Furthermore, this configuration negates the need to couple the optical device 4 and the drive circuit 6 to each other with bonding wires, thereby facilitating achievement of the low profile of the optical module 1.

In the optical module 1, the first electrodes 31 of the optical coupling member 3 and the second electrodes 44 and 45 of the optical device 4 are joined to each other via the AuSn solder layers 47. As described above, the AuSn solder is melted, which allows the optical device 4 to be joined to the optical coupling member 3. Accordingly, in comparison with the case where Au or Cu bumps are formed and the optical device 4 is joined to the optical coupling member 3 by heat or ultrasonic waves, the accuracy of the distance between the optical device 4 and the first lens surface 35a is improved, thereby allowing the optical coupling efficiency of the optical module 1 to be improved. The case of joining using AuSn solder can have a production tolerance or a mounting tolerance that is reduced to be about one tenth in comparison with the case of joining using Au or Cu bumps.

In the optical module 1, the lens 35 is formed of a material that allows the communication light C having a predetermined wavelength to transmit therethrough. In this case, the absorption of the communication light C by the lens 35 is suppressed. Consequently, the optical coupling efficiency in the optical module 1 can be further improved.

In the optical module 1, the main body 30 of the optical coupling member 3 may be formed of a material transparent to visible light. According to this embodiment, the visibility is improved. Consequently, when the optical device 4 is mounted to the optical coupling member 3, the mutual positional relationship can be easily confirmed in any direction. Therefore, each member can be mounted more smoothly. The main body 30 may be made of a material that is not transparent to visible light.

In the optical module 1, the lens 35 may be formed of the same material as that of the main body 30 of the optical coupling member 3. According to this embodiment, even in a case where the environmental temperature is changed, the stress deformation due to the difference in linear expansion coefficient between the main body 30 of the optical coupling member 3 and the lens 35 is unlikely to occur. Consequently, the deviation in the optical axis of the lens 35 and the variation in the distances between the members can be small. As a result, the operation temperature range of the optical module 1 can be wide.

In the optical module 1, the main body 30 of the optical coupling member 3 is formed of a heat-resistant material. According to this embodiment, the heat resistance of the optical coupling member 3 can be improved. Accordingly, in the optical module 1, for example, the AuSn solder is melted, which can allow the optical device 4 to be joined to the optical coupling member 3 with the AuSn solder layers 47, and improve the mounting position accuracy.

In the optical module 1, the optical coupling member 3 further includes the stop surfaces 36b that are provided in the second holes 34 and regulate the distal end positions of the optical fibers 5, which have been inserted into the second holes 34, at the positions apart from the lenses 35. According to this embodiment, improvement in the position accuracy of the optical fiber 5 can further improve the optical coupling efficiency in the optical module 1. Moreover, the contact of the optical fibers 5 with the optical device 4 during insertion of the optical fibers 5 into the second holes 34 is further suppressed. Consequently, the operation of inserting the optical fibers 5 can be performed more easily, and the productivity of the entire device can be improved.

In the optical module 1, the lens 35 further includes the second lens surface 35b adjacent to the second hole 34. The optical axis of the second lens surface 35b coincides with the optical axis of the first lens surface 35a and the central axis of the second hole 34. Consequently, according to the optical module 1, the optical coupling efficiency between the optical device 4 and the optical fibers 5 can be further improved.

The optical module 1 may further comprise the optical fibers 5 inserted into the second holes 34. According to this embodiment, the optical module 1 that comprises the optical fibers 5 can be configured, and the optical couplings between the optical devices 4 and the respective optical fibers 5 can be preliminarily adjusted.

Although one embodiment of the present invention has been described, the present invention is not limited to the embodiment described above, and can be modified in a range without departing from the spirit of the present invention. For example, the diameter of the first hole 33 is not necessarily constant from the first surface 3a to the first lens surface 35a of the lens 35. For example, the structure where the diameter decreases from the first surface 3a to the first lens surface 35a of the lens 35 may be adopted. The diameter of the second hole 34 is not necessarily constant from the second surface 3b to the second lens surface 35b of the lens 35. The structure where the diameter decreases from the second surface 3b to the second lens surface 35b of the lens 35 may be adopted. Furthermore, the diameter of the first hole 33 is not necessarily equivalent to the diameter of the second hole 34.

Alternatively, the optical module may have the following configuration. In the following modification examples, the points different from those of the embodiment described above are mainly described, and description of the common points is omitted.

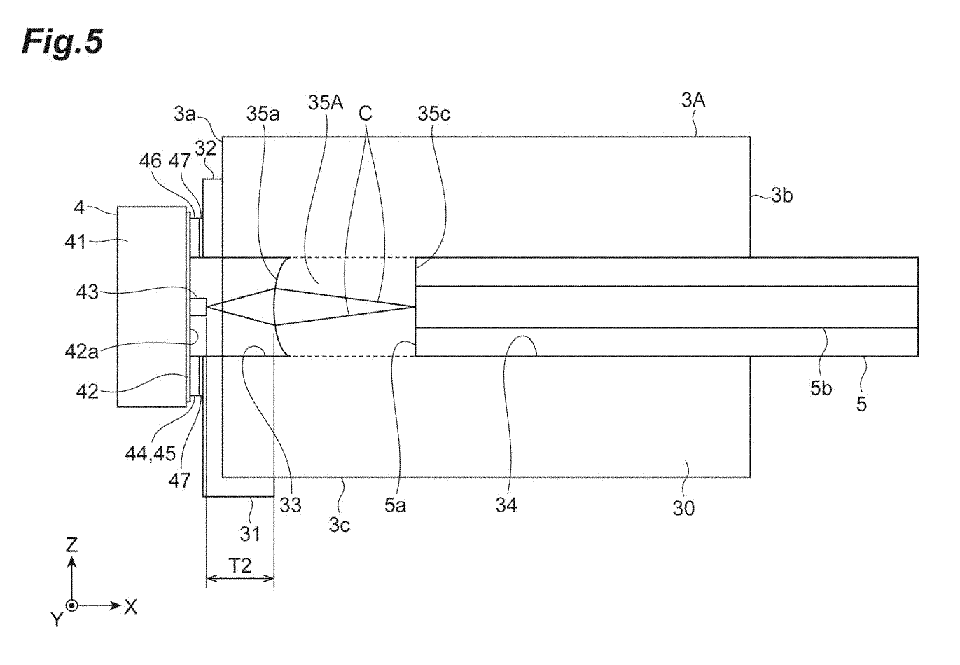

FIG. 5 is a sectional view showing the modification example of the connection structure between the optical coupling member and the optical device that are included in the optical module shown in FIG. 1. As shown in FIG. 5, in the optical module according to the modification example, the internal configuration of the optical coupling member 3A to which the optical device 4 is joined is different from that of the optical coupling member 3. Unlike the optical coupling member 3, the optical coupling member 3A includes a lens 35A that comprises only the first lens surface 35a, and does not comprise the other second lens surface 35b, but comprises a flat surface 35c instead. The optical coupling member 3A does not include the stop member 36, and thus, the optical fiber 5 is in contact directly with the flat surface 35c of the lens 35. Likewise, also in the optical module including such an optical coupling member 3A, the light from the optical device 4 is allowed to be condensed by the first lens surface 35a, and to enter the core 5b of the optical fiber 5. Furthermore, the light from the optical fiber 5 is allowed to be condensed by the first lens surface 35a and to enter the optical device 4 (light receiving device). That is, even the lens 35A including the single lens surface can achieve a high optical coupling efficiency. The other effects can be exerted in an analogous manner.

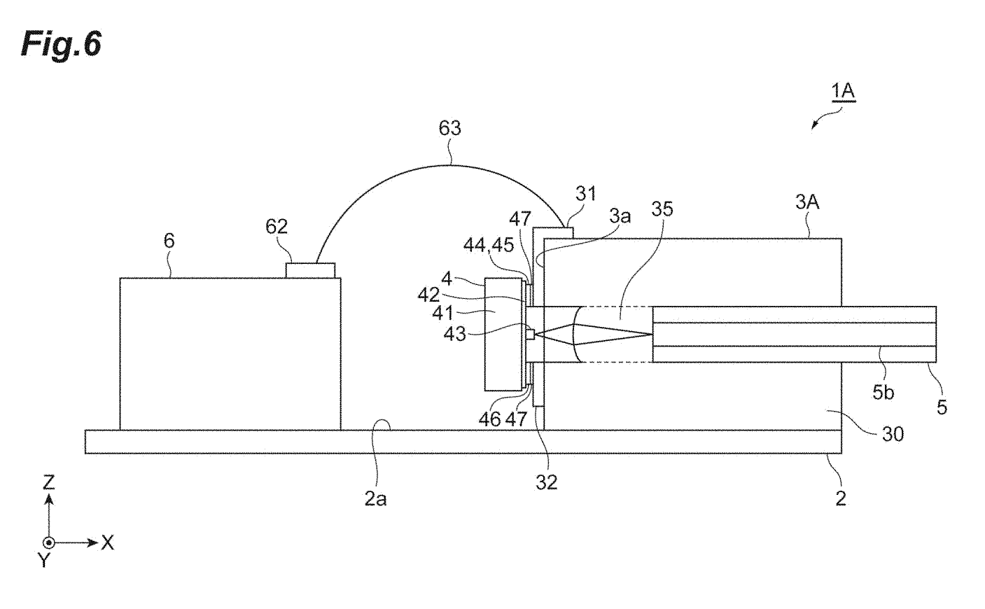

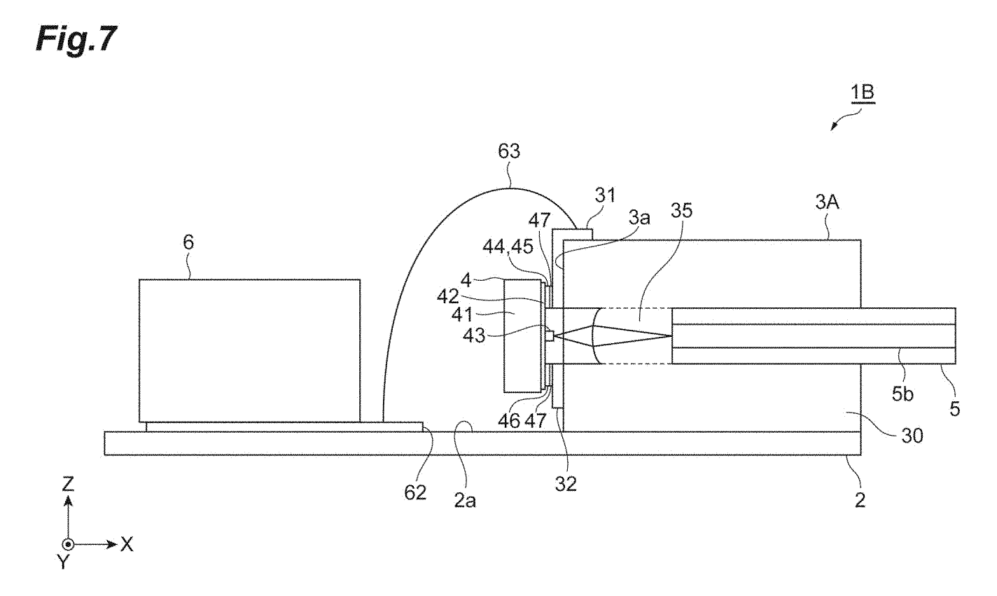

In the optical module 1 described above, the optical device 4 is connected to the drive circuit 6 via the electrodes 61 provided on the circuit board 2. Alternatively, an optical module 1A as shown in FIG. 6 may be adopted. In the optical module 1A, the optical device 4 is electrically connected to the drive circuit 6 via electrodes 62, a wire 63, the first electrodes 31 and the second electrodes 44 and 45. As shown in FIG. 7, in an optical module 1B, the optical device 4 may be electrically connected to the drive circuit 6 via the electrodes 62, the wire 63, the first electrodes 31 and the second electrodes 44 and 45 on the circuit board. Even such a configuration can achieve a high optical coupling efficiency.

### Examples

Hereinafter, the present invention is further specifically described on the basis of comparative example and examples. However, the present invention is not limited to the following examples.

In the comparative example and the examples, simulations that calculate optical coupling efficiencies in various conditions (in consideration of Fresnel loss) were performed. Conditions common to the comparative example and the examples are described. In the configuration of the optical module according to the example, the connection structure shown in FIGS. 4 and 5 was adopted, and the optical device 4 was a VCSEL device. The NA of the optical device 4 was 0.24, and the NA of the optical fiber 5 was 0.2. The size of the light emitting region 43 of the optical device 4 was 7.5 μm. The joining methods between the optical coupling member 3 and the optical device 4 were two types which were AuSn solder joining and bump joining.

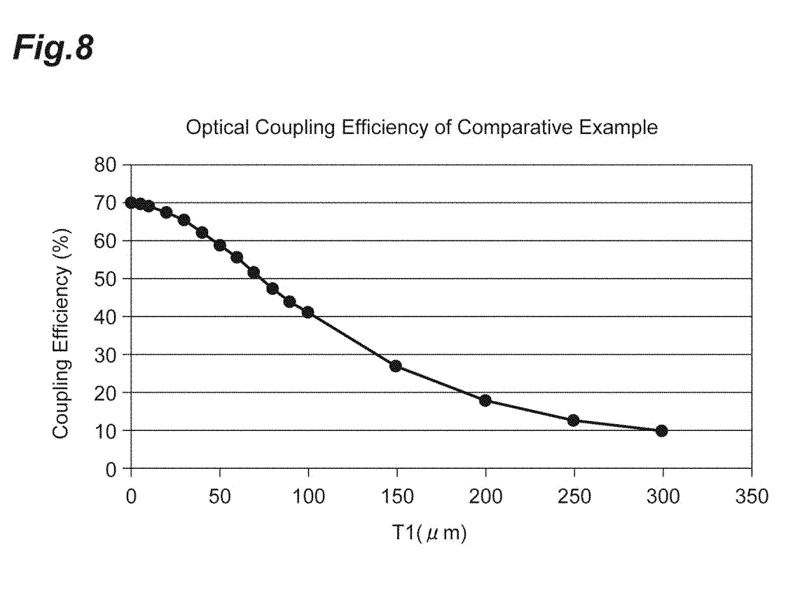

The comparative example adopted an optical module that has the conventional connection structure where the lens coupling member did not include the lens 35 and the stopper 36, and the optical fiber 5 inserted in the through-hole formed from the first surface 3a to the second surface 3b was coupled to the optical device 4 by what is called butt joint coupling. As to the comparative example, the distance from the light emitting region 43 of the optical device 4 to the distal end Sa of the optical fiber 5 was assumed as a parameter T1, and the simulation was performed. As shown in FIG. 8, in the comparative example, the optical coupling efficiency significantly decreased with increase in a distance T1. In the optical module in the comparative example, even in a case where the distance T1 was 0, the optical coupling efficiency was about 70% at the maximum.

As to the examples, with both the optical module 1 (the first embodiment; see FIG. 4) according to the embodiment and an optical module according to a modification example (the second example; see FIG. 5), simulations were performed.

In the first example having the configuration shown in FIG. 4, the coupling tolerance of the AuSn solder coupling, the coupling tolerance of bump coupling, a distance T2 from the light emitting region 43 of the optical device 4 to the first lens surface 35a, and a distance T3 from the second lens surface 35b to the distal end 5a of the optical fiber 5 were adopted as parameters, and simulations were performed. As shown in Table 1, according to the first example, a tolerance of ±2 μm (including the production tolerance and the mounting tolerance) corresponding to the coupling tolerance of solder joining was set, and a simulation was performed. It could be identified that the optical coupling efficiency was maintained to be about 85%. A tolerance of about ±20 μm (including the production tolerance and the mounting tolerance) corresponding to the coupling tolerance of bump joining was set, and a simulation was performed. It could be identified that the optical coupling efficiency was maintained to be about 85% with the tolerance ranging from −20 to 0 μm, while it could be identified that the optical coupling efficiency slightly decreased with increase in tolerance from 0 to 20 μm.

TABLE 1

| First example | Tolerance (μm) | Optical coupling efficiency (%) |
|---|---|---|
| Solder joining | −2 | 85.3 |
| | 0 | 85.2 |
| | +2 | 85.0 |
| Bump joining | −20 | 85.3 |
| | 0 | 85.2 |
| | +20 | 70.4 |

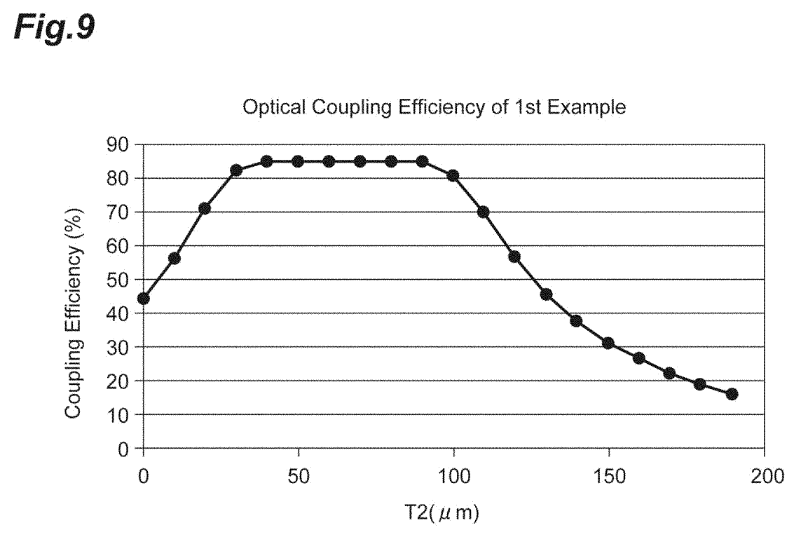

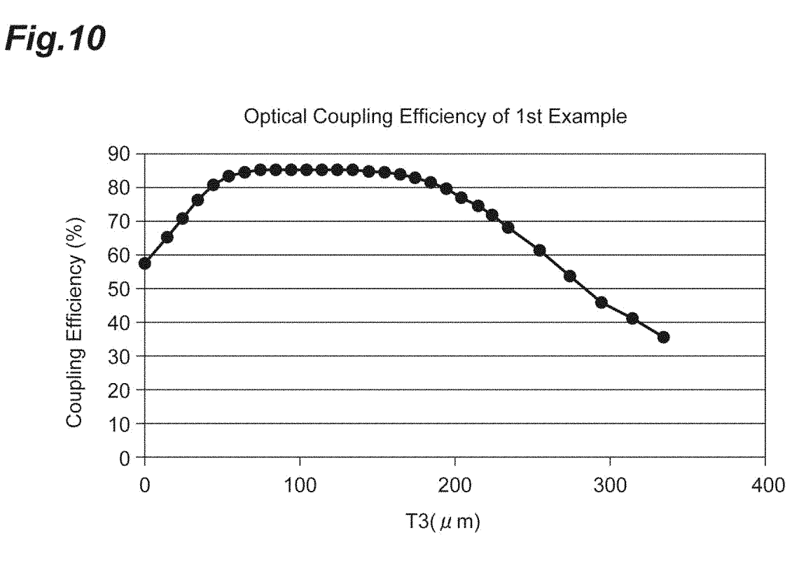

As shown in FIG. 9, as to the first example, even in a case where the distance T3 was set to be constant while the distance T2 was varied, it could be identified that the optical coupling efficiency could be maintained to be about 85% with the distance T2 up to 100 μm. As shown in FIG. 10, as to the first example, even in a case where the distance T2 was set to be constant while the distance T3 was varied, it could be identified that the optical coupling efficiency could be maintained to be about 80% to 85% with the distance T3 up to 200 μm.

In the second example having the configuration shown in FIG. 5, the coupling tolerance of the solder coupling, the coupling tolerance of bump coupling, and the distance T2 from the light emitting region 43 of the optical device 4 to the first lens surface 35a were adopted as parameters, and simulations were performed. As shown in Table 2, according to the second example, a tolerance of ±2 μm (including the production tolerance and the mounting tolerance) corresponding to the coupling tolerance of solder joining was set, and a simulation was performed. It could be identified that the optical coupling efficiency was maintained to be about 94%. A tolerance of about ±20 μm (including the production tolerance and the mounting tolerance) corresponding to the coupling tolerance of bump joining was set, and a simulation was performed. It could be identified that the optical coupling efficiency could be maintained to be about 94% with the tolerance ranging from −20 to 0 μm, while it could be identified that the optical coupling efficiency slightly decreased with increase in tolerance from 0 to 20 μm.

TABLE 2

| Second example | Tolerance (μm) | Optical coupling efficiency (%) |
|---|---|---|
| Solder joining | −2 | 93.6 |
| | 0 | 93.6 |
| | +2 | 93.6 |
| Bump joining | −20 | 93.5 |
| | 0 | 93.6 |
| | +20 | 80.2 |

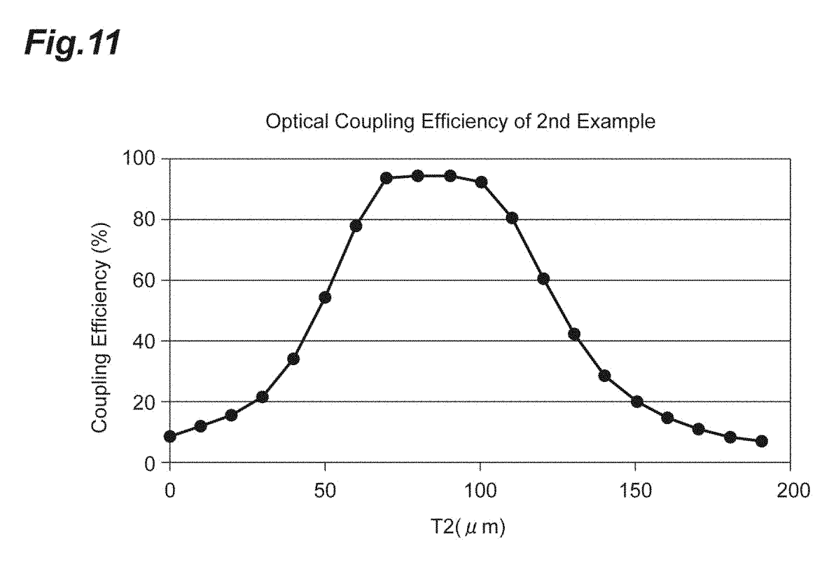

As shown in FIG. 11, as to the second example, even in a case where the distance T2 was varied, it could be identified that the optical coupling efficiency could be 80% or higher with the distance T2 ranging from 60 to 110 μm. That is, it could be identified that a high optical coupling efficiency could be maintained.

As described above, the optical coupling between the optical device 4 and the optical fiber 5 using the optical coupling member that internally comprised the lens 35 as shown in each example allowed achievement of a higher coupling efficiency than that of the butt joint coupling as in the comparative example to be confirmed. Coupling of the optical device 4 to the optical coupling member 3 with AuSn solder coupling could achieve a lower tolerance than that in the case of bump joining. Consequently, it could be also confirmed that a higher optical coupling efficiency could be achieved.

Next, the optical modules corresponding to the first example and the comparative example were fabricated according to the following details, and the light transmission characteristics were evaluated. First, the optical coupling member 3 that included the first and second holes 33 and 34, the stopper 36 including the stop surface 36b, the lens 35 including the first and second lens surfaces 35a and 35b, the first electrodes 31, and the AuSn solder layers 47 was fabricated using TEMPAX, which is heat resistant glass. Then, the second electrodes 44 and 45 were disposed to face and be in contact with the AuSn solder layers 47 provided at the first electrodes 31. Then, the temperature of the AuSn solder layers 47 was increased to about 280° C. to melt the AuSn solder layers 47, which joined the optical device 4 to the optical coupling member 3. These joined members were electrically connected to the drive circuit with wires, and were mounted on the circuit board. Lastly, the optical fiber 5 was inserted into the second holes 34.

As to the comparative example, an optical connection structure that did not include the lens surface was fabricated in a manner analogous to that described above, and was mounted on the circuit board. Then, the optical fiber 5 was inserted into the second holes 34.

Next, these assemblies were mounted on evaluation boards. First, the light transmission characteristics at 25 Gbps were evaluated at room temperature. As a result, on the assembly that included the optical module 1 according to the first example including the lens surfaces, the mask margin of the optical eye diagram was about 40%, and the receiver's sensitivity was −10 dBm at a bit error rate (BER) of 1E-12. Meanwhile, on the assembly that included the optical module according to the comparative example that does not include the lens surface, the mask margin of the optical eye diagram was about 10%, and the receiver's sensitivity was −5 dBm at a BER of 1E-12. As described above, it could be identified that use of the structure according to one embodiment of the present invention could significantly improve the light transmission characteristics.

Next, the light transmission characteristics at 25 Gbps were evaluated at 85° C. As a result, on the assembly that included the optical module 1 according to the first example including the lens surfaces, the transceiver's good eye opening and 25 Gbps error-free (BER<1E-12) optical transmission were confirmed. Meanwhile, on the assembly that included the optical module according to the comparative example that did not include the lens surface, the transceiver's eye was rather closed and 25 Gbps error-free (BER<1E-12) optical transmission could not be obtained. As described above, it could be identified that use of the structure according to the embodiment of the present invention could significantly increase the operation temperature range.

Furthermore, on the assembly that included the optical module according to the first example having the lens surfaces, a heat of 265° C. that is a typical reflow temperature was applied, and subsequently the light transmission characteristics were evaluated at room temperature and at 85° C. The light transmission characteristics were not changed before and after the heat, and the reflow resistance could be also identified.

As described above, it was identified that the optical module that had a high optical coupling efficiency and operated in a wide temperature range could be achieved.

What is claimed is:

1. An optical module, comprising:
an optical coupling member comprising a first surface, a second surface opposite to the first surface, a first hole extending from the first surface toward the second surface, a second hole extending from the second surface toward the first surface, and a lens provided between the first and second holes wherein the lens includes a first lens surface adjacent to the first hole; and
an optical device comprising an optical region that includes at least one of a light emitting region or a light receiving region on a surface of the optical device, the optical device being mounted on the first surface of the optical coupling member such that the optical region faces the first hole,
wherein a central axis of the first hole, an optical axis of the first lens surface, and a central axis of the second hole are located on an identical axis.

2. The optical module according to claim 1,
wherein a depth of the first hole from the first surface to the first lens surface is shorter than a diameter of the first hole.

3. The optical module according to claim 1,
wherein a depth of the first hole from the first surface to the first lens surface is shorter than a depth of the second hole from the second surface to the lens.

4. The optical module according to claim 1,
wherein a depth of the first hole from the first surface to the first lens surface is shorter than a longitudinal length of the lens.

5. The optical module according to claim 1,
wherein the first lens surface is located in a bottom of the first hole.

6. The optical module according to claim 1,
wherein the second hole has a constant diameter from the second surface to the lens.

7. The optical module according to claim 1,
wherein the first hole has a constant diameter from the first surface to the lens, and the diameter of the first hole is equivalent to the diameter of the second hole.

8. The optical module according to claim 1,
wherein the optical coupling member further comprises a first electrode on the first surface, and the optical device further comprises a second electrode on the surface thereof, and
the first electrode and the second electrode are electrically connected to each other.

9. The optical module according to claim 8,
wherein the first electrode and the second electrode are joined to each other via AuSn solder.

10. The optical module according to claim 1,
wherein the lens has permeability which allows light having a predetermined wavelength to transmit through the lens.

11. The optical module according to claim 10,
wherein the optical coupling member comprises a main body having the first and second holes internally configured in the main body, and, the main body is formed of a material transparent to visible light.

12. The optical module according to claim 11,
wherein the lens is formed integrally with the main body.

13. The optical module according to claim 12,
wherein the lens is formed of a material identical to a material of the main body.

14. The optical module according to claim 11,
wherein the main body is formed of a heat-resistant material.

15. The optical module according to claim 1,
wherein the optical coupling member further comprises a stopper provided in the second hole, the stopper regulating a distal end position of an optical fiber inserted into the second hole at a position apart from the lens.

16. The optical module according to claim 1,
wherein the lens includes a second lens surface adjacent to the second hole, and an optical axis of the second lens surface coincides with a central axis of the second hole.

17. The optical module according to claim 16,
wherein the second lens surface is located in a bottom of the second hole.

18. The optical module according to claim 1, further comprising
an optical fiber inserted into the second hole.

19. The optical module according to claim 18,
wherein a distal end of the optical fiber is apart from the surface of the optical device.

20. The optical module according to claim 1, further comprising
a drive circuit configured to control the optical device;
a circuit board that mounts the optical coupling member and the drive circuit thereon; and
at least one electrode disposed on the circuit board, the electrode electrically connecting the drive circuit to the optical device through the optical coupling member.
